(19) United States
(12) Patent Application Publication
(10) Pub. No.: US 2008/0069202 A1
(43) Pub. Date: Mar. 20, 2008

(54) Video Encoding Method and Device

(75) Inventors: Marc Baillavoine, Versailles (FR); Joel Jung, Le Mesnil Saint Denis (FR); Jean-Christophe Amiel, Paris (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/794,802

(22) PCT Filed: Dec. 30, 2005
(86) PCT No.: PCT/FR05/03313

§ 371 Date: Jul. 6, 2007

(30) Foreign Application Priority Data
Jan. 7, 2005 (FR) 0500171

(51) Int. Cl. H04B 1/66

(52) U.S. Cl. 375/240.01; 375/E07.026

(57) ABSTRACT

Successive images of a video image are encoded in order to generate parameters which are included in an output flow that is to be transmitted to a decoder. The encoding of certain images is carried out in inter mode in relation to one or several previous images of the sequence, said previous images being temporarily stored in an image memory. Return information on the restoration of the images of the video sequence by the decoder are received by the encoder and analyzed in order to evaluate the time lag of the return channel in relation to the transmission of the output flow. The encoder determines an amount of memory allocated to the image memory in the decoder according to the evaluated time lag and indicates said amount of memory to the decoder.

The present invention relates to video coding techniques.

It applies to situations where a coder producing a coded video signal stream sent to a video decoder benefits from a return channel, on which the decoder side provides information indicating, explicitly or implicitly, whether or not it has been possible to appropriately reconstruct the pictures of the video signal.

Many video coders support an inter-picture coding mode (“inter-frame coding”, hereinafter Inter coding), in which the motion between the successive pictures of a video sequence is estimated so that the most recent picture is coded in relation to one or more previous pictures. A motion estimation is performed in the sequence, the estimation parameters are quantized and dispatched to the decoder, and the estimation error is transformed, quantized and dispatched to the decoder.

Each picture of the sequence can also be coded without reference to the others. This is what is called Intra coding (“intra-frame coding”). This coding mode utilizes the spatial correlations within a picture. For a given transmission throughput from the coder to the decoder, it affords inferior video quality to Inter coding since it does not exploit the temporal correlations between the successive pictures of the video sequence.

Commonly, a video sequence portion has its first picture Intra coded then the following pictures Inter coded. Information included in the output stream from the coder indicates the Intra and Inter coded pictures and, in the latter case, the reference picture or pictures(s) to be employed.

Several coding standards, among which the H.264 standard of the International Telecommunications Union (“Advanced video coding for generic audiovisual services”, ITU-T, May 2003), make it possible to predict the picture to be Inter coded with respect to several reference pictures over time, and not with respect to the immediately preceding picture alone. The coder and the decoder must then share a picture memory of a certain size. There exist messages from the coder to the decoder making it possible to change the size of the picture memory. Their aim is to improve the coding quality, since by preserving several reference pictures it becomes possible to predict the current picture more effectively.

For Inter coding, the picture memory contains a window of N reconstructed pictures immediately preceding the current picture (short-term pictures) and possibly one or more pictures that the coder has marked specially (long-term pictures). The number N of short-term pictures retained in memory is monitored by the coder. It is usually limited so as not to occupy too many resources of the stations in communication. The refreshing of these short-term pictures occurs after N pictures of the video stream.

A problem with Inter coding is its behavior in the presence of transmission errors or packet losses over the communication channel between the coder and the decoder. The degradation or the loss of a picture propagates over the following pictures until a new Intra coded picture arises.

It is commonplace for the mode of transmission of the coded signal between the coder and the decoder to cause total or partial losses of certain pictures. Such losses result for example from the loss or the overly late arrival of certain data packets when the transmission takes place over a packet network with no guarantee of delivery such as an IP (Internet Protocol) network. Losses can also result from errors introduced by the transmission channel beyond the correction capabilities of the error-correcting codes employed.

In an environment prone to diverse losses of signal, it is necessary to provide mechanisms for improving the quality of the picture at the decoder. One of these mechanisms is the use of a return channel, from the decoder to the coder, on which the decoder informs the coder that it has lost all or some of certain pictures. In certain cases, it is the properly reconstructed pictures that the decoder indicates to the coder and the latter can, on the contrary, deduce therefrom which pictures may possibly have been lost.

The coder can then make coding choices to correct or at least reduce the effects of the transmission errors. Current coders simply return an Intra coded picture, that is to say without reference to the pictures previously coded in the stream and that might contain errors.

These Intra pictures make it possible to refresh the display and to correct errors due to transmission losses. But they are of inferior quality to the Inter pictures. Thus, the usual mechanism for compensating for picture losses gives rise despite everything to a degradation in the quality of the signal played back for a certain time after the loss.

Likewise, U.S. Pat. No. 6,487,316 envisages, in an embodiment, selecting the acknowledgment mode as a function of the conditions observed on the channel between the coder and the decoder, without however culminating in satisfactory quality.

An aim of the present invention is to improve the resistance of a coded video signal to transmission errors when a return channel is present from the decoder to the coder.

The invention thus proposes a video coding method, comprising the following steps:
coding successive pictures of a video sequence so as to generate coding parameters, the coding of at least one picture being effected in relation to at least one previous picture of the video sequence, said previous picture being temporarily recorded in a picture memory;
including the coding parameters in an output stream to be transmitted to a station comprising a decoder;
receiving, from said station, return information about the playback of the pictures of the video sequence by the decoder;
analyzing the return information so as to evaluate a delay of the return channel with respect to the transmission of the output stream; and
determining a quantity of memory allocated to the picture memory in the decoder as a function of the evaluated delay, and indicating said quantity of memory to the decoder.

The fast refreshing of the short-term pictures in the picture memory of the decoder (and of the coder) makes it possible to resume the Inter coding following a picture loss only if the size (N) of the stored window is sufficiently large.

It would be possible to consider systematically taking the maximum possible size, but this would not be an effective management of the resources in terms of consumption and calculation power. The dynamic adaptation of the quantity of memory allocated to the picture memory, in accordance with the invention, is particularly useful for apparatuses having constraints in terms of consumption and memory access.

This adaptation of the size of the picture memory allows the coder to maximize the probability that at any moment it has available at least one reliable reference picture so as to be able to restart the Inter coding following the detection of a picture loss.

The method makes it possible in numerous cases to maintain the Inter coding mode when losses are detected. In a preferred embodiment, the analysis of the return information furthermore comprises a step of identifying a picture that has not been played back or has been played back poorly by the decoder, and a step of controlling the coding means, in response to the identification of a picture that has not been played back or has been played back poorly, so that at least one following picture of the video sequence is coded in relation to at least one reference picture recorded in the picture memory for a time greater than the evaluated delay of the return channel.

For a given transmission throughput, the method generally provides a better quality of video playback once the channel has been restored.

Another aspect of the invention pertains to a computer program to be installed in a video processing apparatus, comprising instructions for implementing the steps of a video coding method such as defined above during an execution of the program by a calculation unit of said apparatus.

Another aspect of the invention pertains to a video coder, comprising:
means for coding successive pictures of a video sequence so as to generate coding parameters, the coding of at least one picture being effected in relation to at least one previous picture of the video sequence, said previous picture being temporarily recorded in a picture memory;
means for forming an output stream from the coder to be transmitted to a station comprising a decoder, the output stream including said coding parameters;
means for receiving, from said station, return information about the playback of the pictures of the video sequence by the decoder;
means for analyzing the return information so as to evaluate a delay of the return channel with respect to the transmission of the output stream; and
means for determining a quantity of memory allocated to the picture memory in the decoder as a function of the evaluated delay, and for indicating said quantity of memory to the decoder.

Other features and advantages of the present invention will appear in the description hereinafter of nonlimiting exemplary embodiments, with reference to the appended drawings, in which:

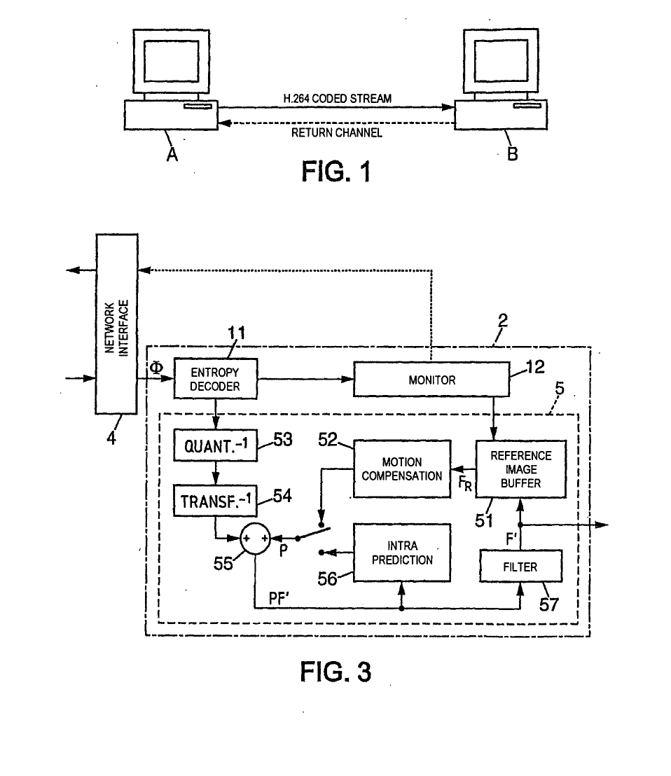

FIG. 1 is a diagram showing two stations in communication, provided with video coders/decoders;

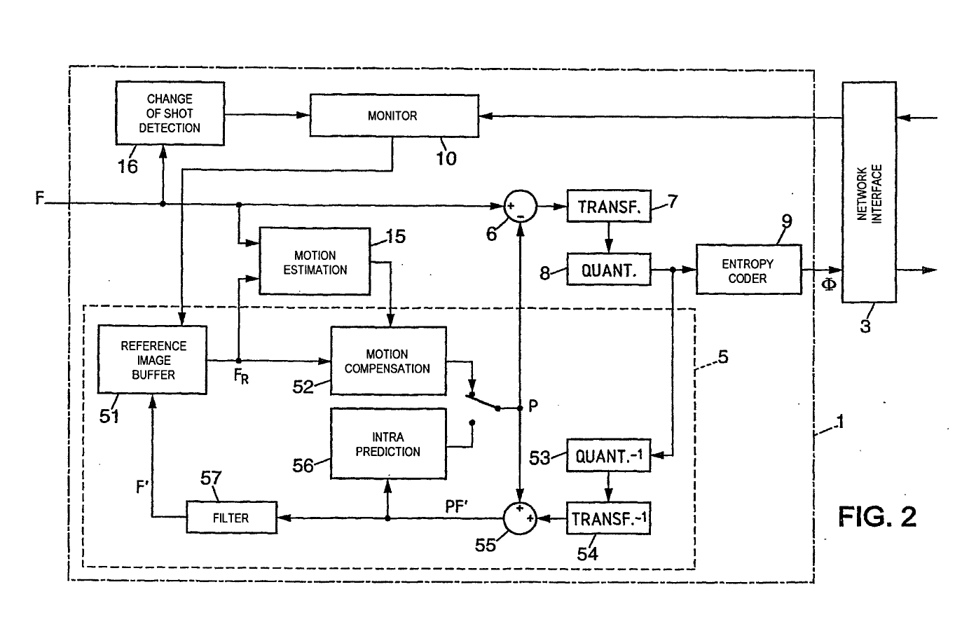

FIG. 2 is a schematic diagram of a video coder according to the invention;

FIG. 3 is a schematic diagram of a video decoder able to play back pictures coded by the coder of FIG. 2.

The coding method according to the invention is for example applicable to videoconferencing over an IP network (prone to packet losses), between two stations A and B (FIG. 1). These stations communicate directly, in the sense that no video transcoding equipment participates in their communication. Each station A, B uses video media coded according to, for example, the ITU-T H.264 standard.

In a prior negotiation phase, for example performed by means of the ITU-T H.323 protocol well known in the field of videoconferencing over IP, the stations A, B agree on an H.264 configuration including the establishment of a return channel.

In the exemplary application to videoconferencing, each station A, B is naturally equipped at one and the same time with a coder and a decoder (codec). Here, we will assume that station A is the sender which contains the video coder 1 (FIG. 2) and that station B is the receiver which contains the decoder 2 (FIG. 3). We are therefore concerned with the H.264 stream sent from A to B and with the return channel from B to A.

The stations A, B consist for example of personal computers, as in the illustration of FIG. 1, each being equipped with video picture capture and playback systems, with a network interface 3, 4 for linkup to the IP network, as well as videoconferencing software executed by the central unit of the computer. For the video codec, this software relies on programs implementing H.264. On the coder side, the program is suitable for including the features described hereinafter. Of course, the codec can also be implemented with the aid of a specialized processor or a specific circuit. The method described can also accommodate coding standards other than H.264.

In H.264, the video picture reconstruction module of the decoder 2 is also found in the coder 1. This reconstruction module 5 is visible in each of FIGS. 2 and 3; it is composed of substantially identical elements bearing the same numerical references 51-57. The prediction residual of a current picture F, that is to say the difference calculated by a subtracter 6 between the picture F and a predicted picture P, is transformed and quantized by the coder 1 (modules 7, 8 of FIG. 2).

An entropy coding module 9 constructs the output stream Φ of the coder 1 which includes the coding parameters of the successive pictures of the video sequence (prediction and quantization parameters of the transformed residual) as well as various monitoring parameters obtained by a monitoring module 10 of the coder.

These monitoring parameters indicate in particular which coding mode (Inter or Intra) is used for the current picture and, in the case of Inter coding, the reference picture or pictures to be employed.

On the decoder side, the stream Φ received by the network interface 4 is submitted to an entropy decoder 11 which recovers the coding parameters and the monitoring parameters, the latter being provided to a monitoring module 12 of the decoder. The monitoring modules 10, 12 supervise respectively the coder 1 and the decoder 2 by providing them with the commands necessary for ascertaining the coding mode employed, designating the reference pictures in Inter coding, configuring and parametrizing, i.e. tuning, the transformation, quantization and filtering elements, etc.

For the Inter coding, each usable reference picture F_{R} is stored in a buffer memory 51 of the reconstruction module 5. Said memory contains a window of N reconstructed pictures immediately preceding the current picture (short-term pictures) and possibly one or more pictures that the coder has marked specially (long-term pictures). The storage area for the window of N pictures is called the picture memory here.

The number N of short-term pictures retained in the picture memory is monitored by the coder 1. It is usually limited so as not to occupy too many resources of the stations A, B. The refreshing of these short-term pictures occurs after N pictures of the video stream.

Each picture marked long-term is retained in the buffer memory 51 of the decoder (and in that of the coder) until the coder produces a corresponding unmarking command. Thus, the monitoring parameters obtained by the module 10 and inserted into the stream Φ also comprise the possible commands for marking and unmarking the long-term pictures.

The prediction parameters for the Inter coding are calculated in a known manner by a motion estimation module 15 as a function of the current picture F and of one or more reference pictures F_{R}. The predicted picture P is generated by a motion compensation module 13 on the basis of the reference picture or pictures F_{R} and of the prediction parameters calculated by the module 15.

The reconstruction module 5 comprises a module 53 which recovers the transformed parameters quantized according to the quantization indices produced by the quantization module 8. A module 54 operates the inverse transformation of the module 7 so as to recover a quantized version of the prediction residual. This is added to the blocks of the predicted picture P by an adder 55 to provide the blocks of a preprocessed picture PF′. The preprocessed picture PF′ is ultimately processed by a deblocking filter 57 to provide the reconstructed picture F′ delivered by the decoder and recorded in its buffer memory 51.

In Intra mode, a spatial prediction is performed in a known manner in tandem with the block coding of the current picture F. This prediction is performed by a module 56 on the basis of the already available blocks of the preprocessed picture PF′.

For a given coding quality, the transmission of Intra coded parameters generally requires a greater throughput than that of Inter coded parameters. Stated otherwise, for a given transmission throughput, the Intra coding of a picture of a video sequence affords inferior quality to its Inter coding.

The selection between the Intra and Inter modes for a current picture is performed by the coder monitoring module 10, for example by being based on detecting the changes of shot within the video sequence. In a known manner, a change of shot can be decided by a detector 16 of the video coder 1 by observing whether the difference between two successive pictures of the sequence has an energy above a detection threshold. In the absence of losses, the picture where a change of shot is detected is typically Intra coded, while the other pictures of the sequence are Inter coded.

The monitoring module 10 furthermore manages the long-term marking of the pictures of the video sequence. By way of example, each detection of a change of shot by the detector 16 can give rise to the long-term marking by the monitoring module 10 of a picture following the detected change of shot, preferably the first picture following the change of shot. In a concomitant manner, the monitoring module 10 can address a command for unmarking the picture (or pictures) previously marked long-term to the decoder.

To minimize the degradation in quality following the detection of a total or partial picture loss with the aid of the information received on the return channel, the method according to the invention favors the resumption of the coding not in Intra but in Inter mode, and preferably in relation to a reference picture contained in the picture memory.

The size N of this picture memory is adapted according to an evaluation of the delay T exhibited by the return channel. This evaluation is carried out on receipt of each return information message transmitted by the decoder on the return channel. If the delay T is expressed as a number of pictures in the video sequence, the number N of pictures retained in the picture memory is taken greater than T, insofar as this is compatible with the memory capacities available to the coder and to the decoder. If Q denotes the largest of the memory sizes (in number of pictures) allocatable to the buffer memory 51 at the coder level and at the decoder level, it is possible for example to take:
N=min(T+U,Q)
where U is an integer equal to or greater than 1. The number Q may have been agreed between the two stations before the establishment of the H.264 coded stream.

The value of N updated after a new evaluation of the delay T is transmitted from the monitoring module 10 of the coder to that 12 of the decoder. In the example of H.264, this transmission can be done by updating the “sequence parameter set”.

The monitoring module 10 of the coder receives and analyzes the information from the return channel. At the moment it is informed of a picture loss at the decoder 2, the current picture, of rank M, is for example coded in the following manner:
in Inter with respect to one or more short-term reference pictures, each recorded in the picture memory for a time greater than the evaluated delay of the return channel, that is to say each of rank lying between M-N and M-T;
in Intra if no sufficiently old reference picture is available or if a change of shot has been detected from the most recent possible reference picture. In this case, the adaptation of the size of the picture memory is carried out as a function of the evaluation of the delay of the return channel.

It will be noted that other strategies for resuming coding after signalling of a loss are possible. The Inter coding with respect to one or more short-term reference pictures can for example be performed on condition that the detector 16 has not signalled any change of shot in the last T pictures of the sequence (between the ranks M-T and M). If despite the adaptation the picture memory remains too small with respect to the delay T (N=Q<T), it is optionally possible to resume the Inter coding with respect to a reference picture corresponding to the last picture marked long-term, on condition that the detector 16 has not signalled any change of shot between this picture marked long-term and the current picture and on condition that this picture marked long-term is of lower rank than M-T. In a variant, reference is preferably made to a picture marked long-term. If such a long-term picture is not available in memory, or if it differs too much from the current picture (for example the difference between the two pictures has a greater energy than the threshold of the change of shot detector 16), it is possible to try to make do with a short-term picture of rank lying between M-N and M-T. The fact of having dynamically adapted the size N of the picture memory as a function of the delay T increases here also the chances of succeeding in Inter coding the current frame, that is to say maximizing its quality for a given throughput.

The return channel can be organized in several ways.

In an embodiment, the monitoring module 12 of the decoder 2 dispatches a message to the return channel each time that it observes a loss, this message indicating the rank of the lost or poorly played back picture. At the moment the monitoring module 10 of the coder 1 receives a message which informs it of a loss affecting a picture of rank L in the sequence (here L is the rank of the most recent picture that the decoder reckons to have been incapable of playing back properly), the delay T can be evaluated as: T=M−L, where M is the rank of the current picture. The delay T thus evaluated is an estimate of the return trip time between the coder and the decoder. The evaluation will be updated on receipt of the next message informing of a picture loss.

In another embodiment, the monitoring module 12 of the decoder 2 dispatches, on the return channel, messages acknowledging the pictures which have been played back properly, by designating them by their ranks. At the moment the monitoring module 10 of the coder 1 receives a message which informs it that a picture of rank L is the most recent which has been played back properly by the decoder, the delay T can be evaluated as: T=M−L, where M is the rank of the current picture. The delay T thus evaluated is also an estimate of the return trip time between the coder and the decoder.

In all cases, the delay corresponds to the difference between the time references of the current picture and of the last picture properly decoded.

Other return channel techniques can be envisaged, especially the various configurations envisaged in the ITU-T H.263+ standard (Appendix N), which are transposable to other standards such as H.264.

1. A video coding method, comprising the following steps:
coding successive pictures of a video sequence so as to generate coding parameters, the coding of at least one picture being effected in relation to at least one previous picture of the video sequence, said previous picture being temporarily recorded in a picture memory;
including the coding parameters in an output stream to be transmitted to a station comprising a decoder;
receiving, from said station, return information about the playback of the pictures of the video sequence by the decoder;
analyzing the return information so as to evaluate a delay of the return channel with respect to the transmission of the output stream; and
determining a quantity of memory allocated to the picture memory in the decoder as a function of the evaluated delay, and indicating said quantity of memory to the decoder.

2. The method as claimed in claim 1, in which the analysis of the return information furthermore comprises the following steps:
identifying a picture that has not been played back or has been played back poorly by the decoder; and
in response to the identification of a picture that has not been played back or has been played back poorly, controlling the coding means so that at least one following picture of the video sequence is coded in relation to at least one reference picture recorded in the picture memory for a time greater than the evaluated delay of the return channel.

3. The method as claimed in claim 2, in which, if no picture is recorded in the picture memory for a time greater than said delay, the coding means are controlled so that the following picture of the video sequence is coded in relation to a reference picture of the video sequence which has been marked long-term, each long-term marked picture having to be retained in memory by the decoder until receipt of a command for unmarking said picture.

4. The method as claimed in claim 1, in which the analysis of the return information comprises, at the moment of receipt of a return information message, the identification according to said message of the most recent picture of the sequence which has been properly played back by the decoder, the delay of the return channel being evaluated on the basis of the deviation between the identified picture and a current picture at the moment of receipt of said message.

5. The method as claimed in claim 1, in which the return information comprises information arising from the decoder, signalling the pictures of the sequence which have or have not been played back.

6. A computer program medium for a video processing apparatus, comprising instructions for implementing the steps of a video coding method as claimed in any one of claims 1 to 5 during an execution of the program by a calculation unit of said apparatus.

7. A video coder, comprising:
means for coding successive pictures (F) of a video sequence so as to generate coding parameters, the coding of at least one picture being effected in relation to at least one previous picture of the video sequence, said previous picture being temporarily recorded in a picture memory;
means for forming an output stream of the coder to be transmitted to a station comprising a decoder, the output stream including said coding parameters;
means for receiving, from said station, return information about the playback of the pictures of the video sequence by the decoder;
means for analyzing the return information so as to evaluate a delay of the return channel with respect to the transmission of the output stream; and
means for determining a quantity of memory allocated to the picture memory in the decoder as a function of the evaluated delay, and for indicating said quantity of memory to the decoder.

8. The video coder as claimed in claim 7, in which the means for analyzing the return information furthermore comprise:
means for identifying a picture that has not been played back or has been played back poorly by the decoder; and
means responding to the identifying of a picture that has not been played back or has been played back poorly, for controlling the coding means so that at least one following picture of the video sequence is coded in relation to at least one reference picture recorded in the picture memory for a time greater than the evaluated delay of the return channel.

9. The video coder as claimed in claim 7, in which said quantity of memory is indicated to the decoder by including a command for adjusting the quantity of memory in the output stream.

10. The video coder as claimed in claim 7, in which the means for analyzing the return information comprises means for identifying, at the moment of receipt of a return information message, the most recent picture of the sequence which, according to said message, has been properly played back by the decoder, the delay of the return channel being evaluated on the basis of the deviation between the identified picture and a current picture at the moment of receipt of said message.
